(19) United States
(12) Patent Application Publication
(10) Pub. No.: US 2010/0235450 A1
(43) Pub. Date: Sep. 16, 2010

(54) Service Management System

(76) Inventor: Chien-Hsun Wu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/483,252

(22) Filed: Jun. 12, 2009

(30) Foreign Application Priority Data
Mar. 10, 2009 (TW) 098107666

(51) Int. Cl. G06F 15/16; G06F 15/173; G06F 17/30

(52) U.S. Cl. 709/206; 709/223; 709/204; 707/E17.044; 370/352

(57) ABSTRACT

A service management system includes a plurality of user service platforms corresponding to a plurality of user groups, each including a plurality of server devices, for providing a plurality of server functions for a user group of the plurality of user groups, a plurality of secondary server management devices, for providing a plurality of service functions, and a primary server management device for managing the plurality of user service platforms and the plurality of secondary server management devices, for providing the plurality of service functions of the plurality of secondary server management devices to the plurality of user groups via the plurality of user service platforms.

### BACKGROUND OF THE INVENTION

1. Field of the Invention

The present invention relates to a service management system, and more particularly, to a service management system capable of integrating service information of all sites and providing differentialized and personalized service.

2. Description of the Prior Art

Evolution of communication technologies changes a mode of human communication, and convenient communication even changes operations of an enterprise especially for customer service, product counsel, etc. For example, in order to provide real time services, a modern enterprise usually uses a telephone service system for providing real time voice services, allowing customers to query specific information at any time, to ask for assistance from customer service, to report back a latest status, etc.

Except for providing real time voice services, the telephone service system of the prior art can further report product information. For example, when a user calls for maintenance for a product, the related company can report back a maintenance status of the product via the telephone service system, to ask the user to decide a follow-up process. Besides, the telephone service system can further remind an employee of the follow-up work process, to maintain work progress smoothly. For example, when the employee travels on official business, the company can remind the employee of the follow-up schedule via the telephone service system and ask the employee for replying a corresponding acknowledgement message, to ensure that the employee can accomplish the follow-up schedule.

Simply speaking, functions of the telephone service system in the prior art can be categorized into two types: the first type is to receive customer requests passively for providing real-time voice services; the second type is to actively release messages to specific staffs and ask for reporting back the status, such as product maintenance process, follow-up schedule progress, etc. However, no matter which function is performed, the main disadvantage of the telephone service system is lack of integration, which becomes more serious with growth of the enterprise organization. As the enterprise organization grows constantly, a single-site enterprise usually evolves into a multi-site enterprise, and even a multi-national enterprise. Under such circumstances, due to differences of telephone frameworks in each country, the enterprise needs to form an independent telephone service system in each site to appropriately provide voice services for serving customers all over the world. Consequently, for the multi-national enterprise, service information of each site will be hard to be integrated without uniformly managing the latest status of each site, which causes that the telephone service system of each site does things in its own way.

In addition, the telephone service system of the prior art cannot provide differentialized services for individuals, which causes unnecessary inconvenience. For example, suppose the enterprise sends an important message to mobile phones of executives by short message method via the telephone service system and asks for reporting back whether related messages are received. If one of the executives cannot receive the important message because the mobile phone thereof is turned off (such as on a flight) or reception environment is poor (such as in a tunnel), the telephone service system of the prior art may send multiple messages repeatedly to the executive, which causes the mobile phone to receive the repeated messages when the mobile phone is on or the reception is improved. Apparently, improvement of this operation is necessary.

### SUMMARY OF THE INVENTION

It is therefore a primary objective of the claimed invention to provide a service management system.

The present invention discloses a service management system, which comprises a plurality of user service platforms corresponding to a plurality of user groups in which each of user service platforms comprises a plurality of server devices, for providing a plurality of server functions for a user group of the plurality of user groups; a plurality of secondary server management devices, for providing a plurality of service functions; and a primary server management device for managing the plurality of user service platforms and the plurality of secondary server management devices, for providing the plurality of service functions of the plurality of secondary server management devices to the plurality of user groups via the plurality of user service platforms.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a service management system according to an embodiment of the present invention.

FIG. 2 is a schematic diagram of a user service platform shown in FIG. 1.

### DETAILED DESCRIPTION

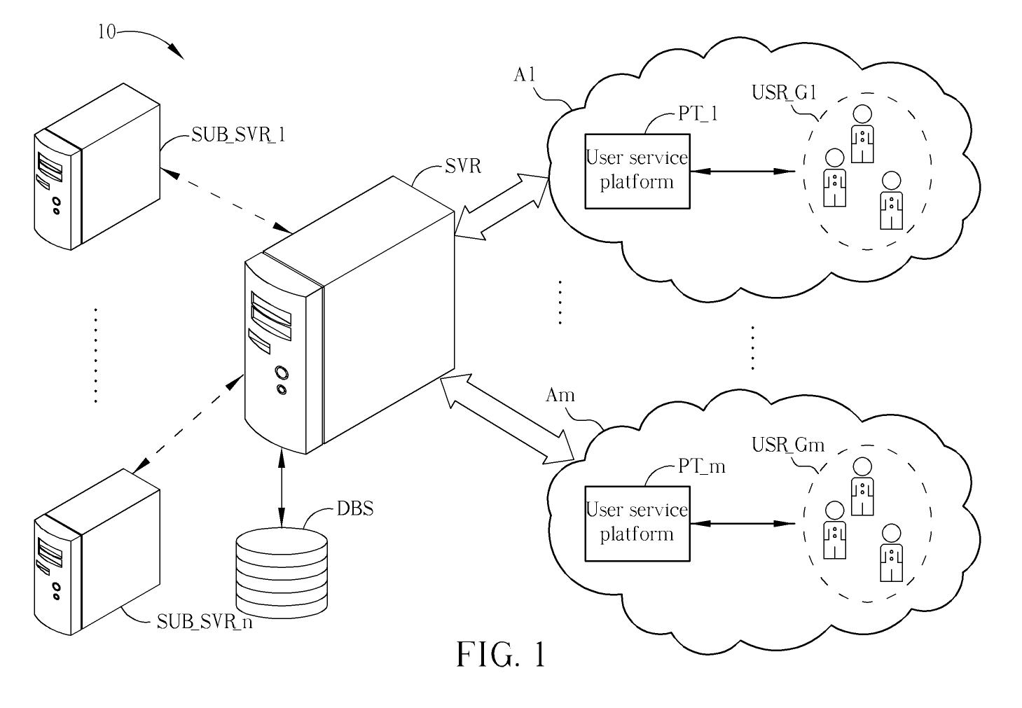

Please refer to FIG. 1, which is a schematic diagram of a service management system 10 according to an embodiment of the present invention. The service management system 10 comprises user service platforms PT_1˜PT_m, secondary server management devices SUB_SVR_1˜SUB_SVR_n, a primary server management device SVR and a database DBS. The user service platforms PT_1˜PT_m are formed in areas A1˜Am, and utilized for providing services for user groups USR_G1˜USR_Gm of the areas A1˜Am. The secondary server management devices SUB_SVR_1˜SUB_SVR_n are utilized for providing n kinds of different service functions, such as product maintenance reports, dispatching acknowledgements, logistics management, emergency reports, etc. The primary server management device SVR can manage the user service platforms PT_1˜PT_m and the secondary server management devices SUB_SVR_1˜SUB_SVR_n, for providing service functions of the secondary server management devices SUB_SVR_1˜SUB_SVR_n to the user groups USR_G1˜USR_Gm via the service platforms PT_1˜PT_m. The database DBS is utilized for storing service information related to the user groups USR_G1˜USR_Gm.

Simply speaking, in the service management system 10, services of a user in the user groups USR_G1˜USR_Gm are provided by the primary server management device SVR via the user service platforms PT_1˜PT_m. Under such circumstances, for a multi-site enterprise, service information of each site can be easily integrated for uniformly managing the latest status.

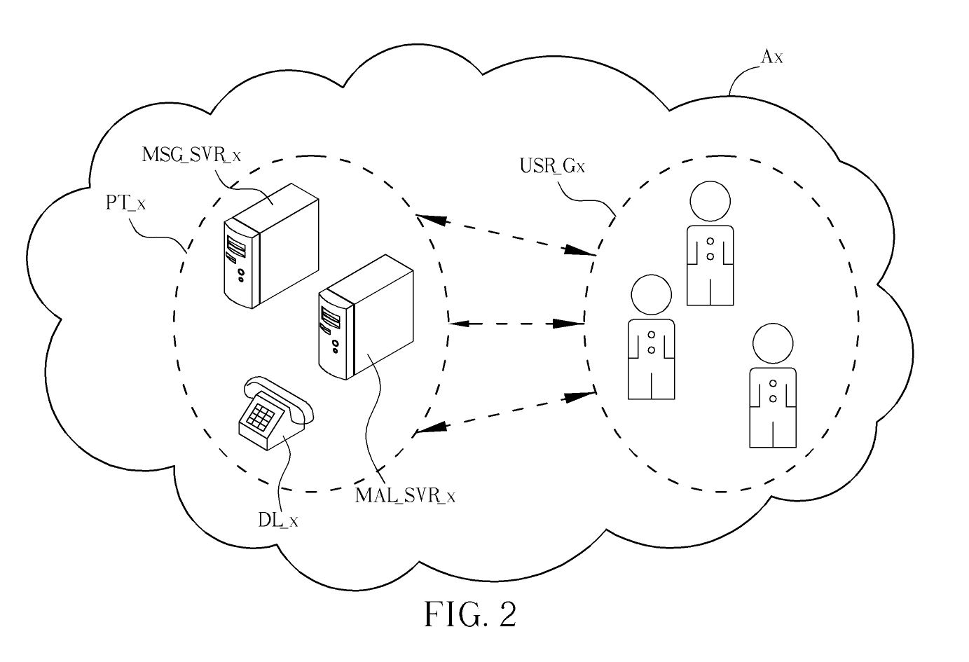

Note that, FIG. 1 illustrates the schematic diagram of the service management system 10 according to the embodiment of the present invention, and those skilled in the art can make modifications and alterations according to different requirements. For example, any user service platform PT_x of the user service platforms PT_1˜PT_m can be composed of a plurality of server devices, for providing a plurality of server functions. Take FIG. 2 as an example, the user service platform PT_x comprises a short message server device MSG_SVR_x, a mail server device MAL_SVR_x and a voice server device DL_x. The short message server device MSG_SVR_x is utilized for providing a function of receiving and sending short messages for a user group USR_Gx of an area Ax. The mail server device MAL_SVR_x is utilized for providing a function of receiving and sending electronic mails (e-mails) for the user group USR_Gx of the area Ax. And, the voice server device DL_x is preferably a voice over internet protocol (VOIP) server device, utilized for providing a function of voice communication for the user group USR_Gx of the area Ax. Under such circumstances, the primary server management device SVR can provide services to users of the user group USR_Gx via short messages, e-mails and voice communication services of the user service platform PT_x.

Furthermore, the users of the service management system 10 can change service methods and store related information into the database DBS according to the requirements of the users. For example, if the service management system 10 provides a schedule remind function for a user UE1 via the voice method, which means the system reminds the user UE1 about a follow-up schedule via the voice method and asks the user UE1 for replying a corresponding acknowledgement message, to ensure that the user UE1 accomplishes the follow-up schedule. Meanwhile, the user UE1 can reply not only the corresponding acknowledgement message, but also switching command, for asking the primary server management device SVR to switch the service type to short messages or e-mails, so the primary server management device SVR can save a corresponding setting into the database DBS. Under such circumstances, when the schedule remind function is provided to the user UE1 again, the primary server management device SVR can provide the service set by the user UE1 according to the information of the database DBS, to prevent causing inconvenience for the user UE1 and ensure the user receiving the follow-up services.

Note that, since the primary server management device SVR integrates all services of the areas A1˜Am after the user UE1 switches the required service type, and consequently, even the user UE1 moves to other area, the primary server management device SVR can still provide the corresponding services according to the requirements of the user without setting up the service type again. Besides, for those users without setting up service types, the primary server management device SVR provides services according to characteristics of each area, such as conventional languages. For example, if the area A1 is located in Japan, the primary server management device SVR provides related services in Japanese for the first priority when a user UE2 of a user group USR_G1 asks the primary server management device SVR for services. Certainly, if the user UE2 further sets up the language, the primary server management device SVR can utilize the set language for the follow-up services.

On the other hands, since the areas A1˜Am might traverse the world, the primary server management device SVR preferably connects to the user service platforms PT_1˜PT_m via the internet, for reducing communication cost. In addition, the primary server management device SVR can also generate a statistic report according to service information related to each user in the database DBS, for administrators to manage the service status in each area, to further optimize service quality and synchronously manage the services of each area.

Note that, in the service management system 10, the services performed by the secondary server management device SUB_SVR_l˜SUB_SVR_n are not confined to specific types, and those skilled in the art can add required services such as voice or e-mails counsel services, product maintenance method inquiry, schedule remind, etc. according to different requirements.

As mentioned above, as an enterprise organization grows constantly, a single-site enterprise usually evolves into a multi-site enterprise, and even a multi-national enterprise, which causes difficulties in each kind of service management. Under such circumstances, in the present invention, the primary server management device SVR can integrate service information of all sites and uniformly manage the latest status of each site via the service management system 10. Besides, the service management system 10 of the present invention can provide differentialized and personalized services targeting on individuals to enhance service quality and increase enterprise competence.

To sum up, the present invention can integrate service information of all sites and uniformly manage the latest status of each site, for providing differentialized and personalized services, to enhance service quality and increase enterprise competence.

Those skilled in the art will readily observe that numerous modifications and alterations of the device and method may be made while retaining the teachings of the invention.

What is claimed is:

1. A service management system comprising:
a plurality of user service platforms corresponding to a plurality of user groups in which each of user groups comprises a plurality of server devices providing a plurality of server functions for a user group of the plurality of user groups;
a plurality of secondary server management devices, for providing a plurality of service functions; and
a primary server management device, for managing the plurality of user service platforms and the plurality of secondary server management devices, for providing the plurality of service functions of the plurality of secondary server management devices to the plurality of user groups via the plurality of user service platforms.

2. The service management system of claim 1, wherein the primary server management device is further utilized for switching a first server device of a user service platform to a second server device for providing services for a user of a user group corresponding to the user service platform when the first server device receives a switching command from the user.

3. The service management system of claim 1, wherein the plurality of server devices of each user service platform comprises:
a short message server device, for providing a function of receiving and sending short messages for users of a corresponding area;
a mail server device, for providing a function of receiving and sending electronic mails (e-mails) for the users of the corresponding area; and
a voice server device, for providing a function of voice communication for the users of the corresponding area.

4. The service management system of claim 3, wherein the voice server device is a voice over internet protocol (VoIP) server device.

5. The service management system of claim 1, wherein the primary server management device connects to the plurality of user service platforms via internet.

6. The service management system of claim 1, wherein the primary server management device is further utilized for providing the plurality of service functions of the plurality of secondary server management devices to users of a plurality of areas according to characteristics of the plurality of user groups.

7. The service management system of claim 6, wherein the characteristics of the plurality of user groups are conventional languages of the plurality of user groups.

8. The service management system of claim 1 further comprising a database for storing service information related to the plurality of user groups.

9. The service management system of claim 8, wherein the primary server management device is further utilized for generating a statistic report according to the service information stored in the database.

10. The service management system of claim 1, wherein the primary server management device is further utilized for identifying a user of the plurality of user groups, to provide service functions to the user according to an attribute of the user.
